(19) United States
(12) Patent Application Publication
(10) Pub. No.: US 2026/0322511 A1
(43) Pub. Date: Oct. 15, 2026

(54) MEASUREMENT COMPENSATION DUE TO RADIO POWER SCALING

(71) Applicant: Telefonaktiebolaget LM Ericsson (publ), Stockholm (SE)

(72) Inventors: Erik LARSSON, Uppsala (SE); David ASTELY, Bromma (SE); Karl WERNER, Segeltorp (SE)

(21) Appl. No.: 19/116,475

(22) PCT Filed: Sep. 30, 2022
(86) PCT No.: PCT/SE2022/050877

§ 371 Date: Mar. 28, 2025

(51) Int. Cl. H04B 17/318; H04W 24/10

(52) U.S. Cl. CPC H04B 17/328; H04W 24/10

(57) ABSTRACT

There is provided techniques for measurement compensations due to radio power scaling. A method comprises providing (S104a, S104b), from a radio unit (200) to a baseband unit (300a), feedback information of radio power scaling as applied by the radio unit (200) to signals scheduled on resource elements in timeslots per carrier. The method comprises compensating (S106), by the baseband unit (300a), measurements made by a user equipment (150) on the signals as transmitted by the radio unit (200), wherein the measurements are received by the baseband unit (300a) from the user equipment (150) in a measurement report, and wherein the measurements are compensated by a factor given by the radio power scaling.

### TECHNICAL FIELD

Embodiments presented herein relate to a method, a radio unit, a baseband unit, computer programs, and a computer program product for measurement compensations due to radio power scaling.

### BACKGROUND

Mobile networks are becoming increasingly more complex with several mobile network operators employing different radio access technologies on a diverse set of frequency bands. Further, the size, weight, and cost of the radio unit should be kept as small as possible without compromising on key performance indicators (KPIs). One approach is therefore to develop radio units capable of multiband operation, or even wideband operation, where one radio unit and antenna system can handle operation at several frequency bands. Further, the output power of the radio unit is a key dimensioning factor in terms of size and weight of the radio unit; more output power requires more cooling which leads to larger size and weight. By employing power pooling, that is, efficiently using the total power in a pooled manner over several carriers (and/or sectors) in a radio unit during multiband operation, the total output power can be reduced without impacting important KPIs, such as network coverage.

One way to achieve power pooling benefits is radio power overbooking. In general terms, radio power overbooking means that the carriers are configured with in total more power than what the radio unit is capable of transmitting. As an introductory illustrative example, consider a radio unit capable of multiband operation and with a maximum total output power of max 60 W. Assume that the radio unit is configured with two carriers, where each carrier can have a maximum output power of 40 W and a bandwidth of 20 MHz. This means that the carriers are typically configured with a power spectral density (PSD) of 2 W/MHz. Evidently, 40+40>60 [W], and hence if both carriers are scheduled to use more than 30 MHZ (30 MHz times 2 W/MHz=60 W), then the PSD needs to be scaled down. However, if the total utilization of both carriers is low enough (i.e., less than 30 MHz), then the PSD target of 2 W/MHz can be kept.

Radio power overbooking is typically transparent to processing in the digital baseband unit, meaning that baseband operations, such as scheduling, will assume always having access to the configured power of the radio unit (i.e., 40 W per each 20 MHz carrier, or 2 W/MHz, in the example above). It is then up to the radio unit to ensure that the total radio capability (60 W in the example above) is never exceeded. The radio unit achieves this by scaling down the power of its carriers whenever the maximum capability of the radio unit is exceeded.

There could be challenges when radio power overbooking is used. Radio resource management (RRM) will be used as an example of this. RRM is one example where prioritized signals, in terms of reference signals, are transmitted.

In general terms, RRM functionalities comprise traffic management and mobility. Traffic management concerns aspects such as how to distribute users (as represented by user equipment served by the network) and traffic over different carriers to best utilize the available resources, taking quality of service (QoS) into consideration (also referred to as load balancing). Mobility control aims at ensuring a seamless transfer of users between different cells (geographical areas) for user equipment in connected mode and handles cell selection/re-selection of users for user equipment in idle mode, and thereby ensures that user equipment connect and camp on the correct cell.

In general terms, RRM functionalities rely on long-term channel state information (CSI) to make good decisions. Such CSI might be acquired via measurement reports sent by the user equipment. Two examples of such measurement report that can be used for the network node to obtain long-term CSI are either L1 feedback or L3measurements, where L1 refers to protocol layer 1 and L3 refers to protocol layer 3.

For L3 measurement reports, the user equipment directly reports long-term CSI by applying so-called layer 3 filtering to average out fast fading and fast interference components. This type of measurement is in fact designed for the purpose of RRM, such as mobility and traffic management. For L1 (CSI) feedback reports, the user equipment reports the instantaneous (non-filtered) CSI. This type of measurement is primarily designed for link adaptation, beam management, etc., that require more instantaneous channel quality, but can be used also for RRM purposes by explicitly filtering the CSI feedback reports at baseband before using them for RRM purposes. One example of a reported parameter is SS-RSRP, short for synchronization signal reference signal received power. SS-RSRP reflects the signal quality of the synchronization signal block (SSB), which is an example of a downlink cell-defining reference signal. Thus, reported parameter gives an estimate of the cell-wide signal quality for a particular cell. This reported parameter can, for example, be used for cell selection/re-selection and for traffic management.

All parameters of measurement reports sent by the user equipment are conditioned on the output power, or power spectral density (PSD), of the radio unit from which the downlink reference signals are transmitted over the air. With power overbooking, the radio unit blindly reduces the power of all transmitted signals on all carriers whenever the maximum power capability of the radio unit is exceeded. In fact, many radio units operate on time-domain signals without any knowledge about their information content. Thus, the radio unit cannot differentiate between different signals, or physical channels. Furthermore, the baseband unit is unaware of how and if the radio unit has scaled the PSD of a particular signal. This means that RRM functionalities that are conditioned and derived based on a fixed PSD will not reflect the true conditions of the radio environment. It would rather appear as if the radio environment is worse than what it truly is. Furthermore, as the baseband unit is unaware of how and if the radio unit has scaled the power, the baseband unit cannot compensate reported parameters from the user equipment that are based on the actual, potentially power scaled, PSD of relevant signals. This unawareness and the fact that power-scaling occurs now and then might thus create fluctuations in signal levels used by the RRM functionalities.

More generally, the network operation contains several control loops that counteract various system uncertainties and ensure a robust and predictable network behaviour. However, different control loops operating at different time-constants can be sensitive to unknown signal fluctuations caused by, for example, power overbooking as discussed above. This kind of signal fluctuation can even lead to system instability.

Hence, there is still a need for improved handling of measurement reports in situations where radio power scaling, such as radio power overbooking, is used.

### SUMMARY

An object of embodiments herein is to address the above issues by providing techniques for measurement compensations when a radio unit is using radio power scaling, such as radio power overbooking.

According to a first aspect there is presented a method for measurement compensations due to radio power scaling. The method is performed by a radio unit. The method comprises providing, to a baseband unit, feedback information of radio power scaling as applied by the radio unit to signals scheduled on resource elements in timeslots per carrier.

According to a second aspect there is presented a radio unit for measurement compensations due to radio power scaling. The radio unit comprises processing circuitry. The processing circuitry is configured to cause the radio unit to provide, to a baseband unit, feedback information of radio power scaling as applied by the radio unit to signals scheduled on resource elements in timeslots per carrier.

According to a third aspect there is presented a radio unit for measurement compensations due to radio power scaling. The radio unit comprises a provide module configured to provide, to a baseband unit, feedback information of radio power scaling as applied by the radio unit to signals scheduled on resource elements in timeslots per carrier.

According to a fourth aspect there is presented a computer program for measurement compensations due to radio power scaling, the computer program comprising computer program code which, when run on processing circuitry of a radio unit 200, causes the radio unit 200 to perform a method according to the first aspect.

According to a fifth aspect there is presented a method for measurement compensations due to radio power scaling. The method is performed by a baseband unit. The method comprises obtaining, from a radio unit, feedback information of radio power scaling as applied by the radio unit to signals scheduled on resource elements in timeslots per carrier. The method comprises compensating measurements made by a user equipment on the signals as transmitted by the radio unit. The measurements are received by the baseband unit from the user equipment in a measurement report. The measurements are compensated by a factor given by the radio power scaling.

According to a sixth aspect there is presented a baseband unit for measurement compensations due to radio power scaling. The baseband unit comprises processing circuitry. The processing circuitry is configured to cause the baseband unit to obtain, from a radio unit, feedback information of radio power scaling as applied by the radio unit to signals scheduled on resource elements in timeslots per carrier. The processing circuitry is configured to cause the baseband unit to compensate measurements made by a user equipment on the signals as transmitted by the radio unit. The measurements are received by the baseband unit from the user equipment in a measurement report. The measurements are compensated by a factor given by the radio power scaling.

According to a seventh aspect there is presented a baseband unit for measurement compensations due to radio power scaling. The baseband unit comprises an obtain module configured to obtain, from a radio unit, feedback information of radio power scaling as applied by the radio unit to signals scheduled on resource elements in timeslots per carrier. The baseband unit comprises a compensate module configured to compensate measurements made by a user equipment on the signals as transmitted by the radio unit. The measurements are received by the baseband unit from the user equipment in a measurement report. The measurements are compensated by a factor given by the radio power scaling.

According to an eighth aspect there is presented a computer program for measurement compensations due to radio power scaling, the computer program comprising computer program code which, when run on processing circuitry of a baseband unit 300a, causes the baseband unit 300a to perform a method according to the fifth aspect.

According to a ninth aspect there is presented a computer program product comprising a computer program according to at least one of the fourth aspect and the eighth aspect and a computer readable storage medium on which the computer program is stored. The computer readable storage medium could be a non-transitory computer readable storage medium.

Advantageously, these aspects provide efficient handling of measurement reports from user equipment when the radio unit is using radio power scaling, such as radio power overbooking, without suffering from the above identified issues.

Advantageously, these aspects ensure that radio power scaling does not affect scenarios where measurements are made on downlink reference signals which have been subjected to radio power scaling.

Advantageously, these aspects therefore facilitate more robust RRM functionalities, e.g., in terms of traffic and mobility handling, and ensure that cell coverage defined by cell-defining reference signals is unaffected.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication network according to embodiments;

FIG. 2 is a schematic illustration of a baseband unit and a radio unit according to embodiments;

FIG. 3 is a flowchart of methods according to embodiments;

FIG. 4 is a schematic illustration of periodic transmission of a downlink reference signal according to embodiments;

FIG. 5 is a schematic illustration of intra-node reports for 3-sector radio sites in a hexagonal deployment according to embodiments;

FIG. 6 is a schematic illustration of inter-node reports for 3-sector radio sites in a hexagonal deployment according to embodiments;

FIG. 7 is a schematic diagram showing functional units of a radio unit according to an embodiment;

FIG. 8 is a schematic diagram showing functional modules of a radio unit according to an embodiment;

FIG. 9 is a schematic diagram showing functional units of a baseband unit according to an embodiment;

FIG. 10 is a schematic diagram showing functional modules of a baseband unit according to an embodiment; and

FIG. 11 shows one example of a computer program product comprising computer readable means according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

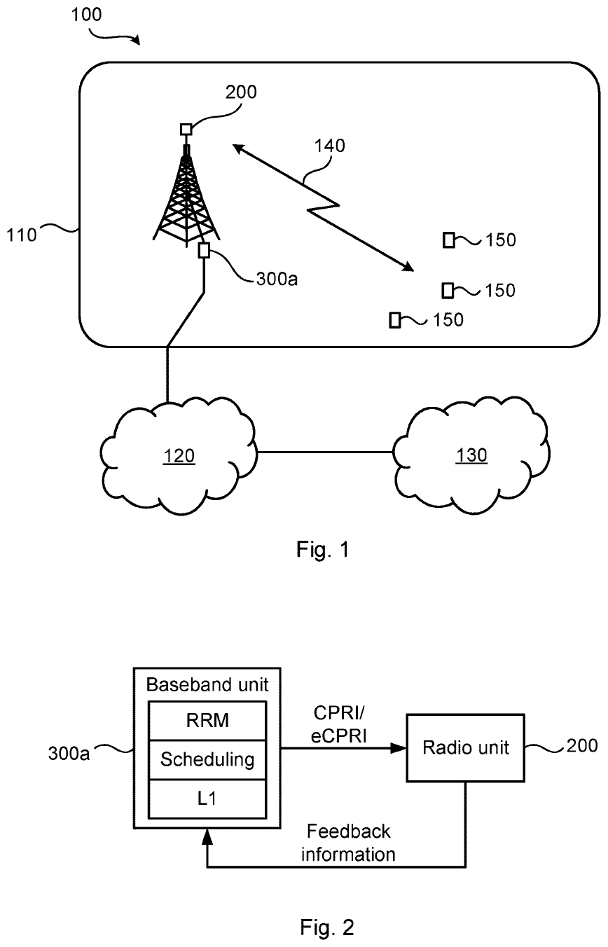

FIG. 1 is a schematic diagram illustrating a communication network 100 where embodiments presented herein can be applied. The communication network 100 could be a third generation (3G) telecommunications network, a fourth generation (4G) telecommunications network, a fifth generation (5G) telecommunications network, a sixth generation (6G) telecommunications, or any evolvement or combination thereof, and support any third generation partnership project (3GPP) telecommunications standard, or IEEE 802 set of local area network (LAN) technical standards, where applicable. The communication network 100 comprises a radio unit 200 configured to provide network access to user equipment 150, over wireless links 140 in a (radio) access network 110. Examples of user equipment 150a:150K are terminal devices, wireless devices, mobile stations, mobile phones, handsets, wireless local loop phones, smartphones, laptop computers, tablet computers, network equipped sensors, network equipped vehicles, customer-premises equipment, and so-called Internet of Things devices. The radio unit 200 is operatively connected to a (digital) baseband unit 300a. Collectively, the radio unit 200 and the baseband unit 300a might be part of a network node. Alternatively, the radio unit 200 is provided separately from the network node. Examples of network nodes are radio access network nodes, radio base stations, base transceiver stations, Node Bs, evolved Node Bs, gNBs, access points, and integrated access and backhaul nodes. The (radio) access network 110 is operatively connected to a core network 120. The core network 120 is in turn operatively connected to a service network 130, such as the Internet. The user equipment 150a:150K are thereby enabled to, via the radio unit 200 and the baseband unit 300a, access services of, and exchange data with, the service network 130.

It is assumed that the radio unit is capable of performing radio power scaling. As noted above there is still a need for improved handling of measurement reports (as sent by the user equipment 150) in situations where radio power scaling, such as radio power overbooking, is used

The embodiments disclosed herein therefore relate to techniques for measurement compensations due to radio power scaling. In order to obtain such techniques there is provided a radio unit 200, a method performed by the radio unit 200, a computer program product comprising code, for example in the form of a computer program, that when run on processing circuitry of the radio unit 200, causes the radio unit 200 to perform the method. In order to obtain such techniques there is further provided a baseband unit 300a, a method performed by the baseband unit 300a, and a computer program product comprising code, for example in the form of a computer program, that when run on processing circuitry of the baseband unit 300a, causes the baseband unit 300a to perform the method.

At least some of the herein disclosed embodiments are based on introducing feedback from the radio unit 200 to the baseband unit 300a, where the radio unit 200 informs the baseband unit 300a whether radio power scaling has occurred during a specific time period (for example a symbol or slot), and if so, how much the PSD has been scaled. The baseband unit 300a can then update its measurement reports accordingly to reflect the actual, non-power-scaled, long-term signal quality, essentially inverting any power scaling applied by the radio unit 200.

FIG. 2 provides an illustration of a baseband unit 300a and a radio unit 200 operatively connected via an interface, such as the Common Public Radio Interface (CPRI) or the enhanced Common Public Radio Interface (eCPRI). An additional feedback link from the radio unit 200 to the baseband unit 300 is provided to inform the baseband unit 300a of any radio power scaling as applied by the radio unit 200. As schematically illustrated in FIG. 2, the baseband unit 300a implements e.g., RRM, scheduling, and protocol layer 1 (L1) processing.

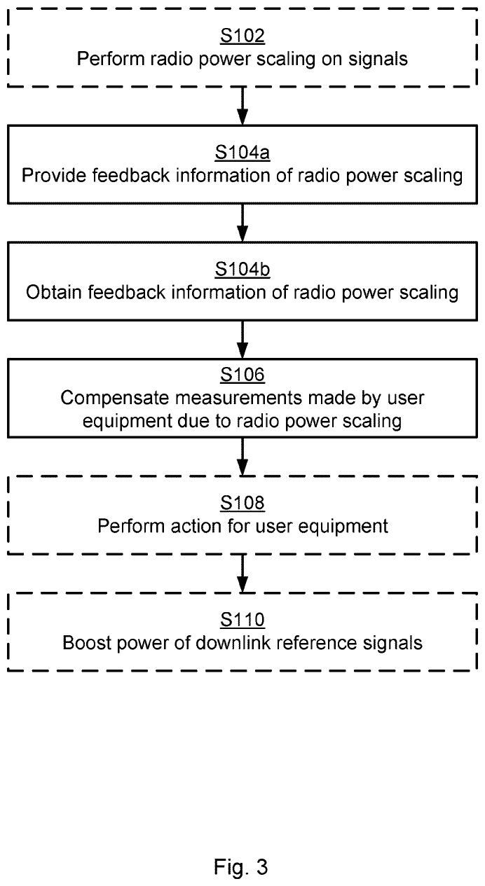

Reference is now made to FIG. 3 illustrating a method for measurement compensations due to radio power scaling (e.g., in terms of adjustment, change, or reduction) as performed by the radio unit 200 and the baseband unit 300a according to an embodiment.

At least some of the herein disclosed embodiments are based on that the radio unit 200 provides feedback information to the baseband unit regarding the power scaling status in the radio unit. The baseband unit 300a can then compensate measurements received in measurement reports from user equipment by a factor corresponding to the effective radio power scaling being used.

S104a: The radio unit 200 provides, to the baseband unit 300a, feedback information of radio power scaling as applied by the radio unit 200 to signals scheduled on resource elements in timeslots per carrier.

S104b: The baseband unit 300a obtains the feedback information from the radio unit 200. As will be disclosed below, the feedback information could be valid for a single time slot, or for multiple time slots. Still further, the baseband unit 300a might receive such feedback information from more than one radio unit. This will also be disclosed below.

S106: The baseband unit 300a compensates measurements made by a user equipment 150 on the signals as transmitted by the radio unit 200. The measurements are received by the baseband unit 300a from the user equipment 150 in a measurement report. The measurements are compensated by a factor given by the radio power scaling.

Embodiments relating to further details of measurement compensations due to radio power scaling as performed by the radio unit 200 and the baseband unit 300a will now be disclosed.

In some aspects, that feedback information of radio power scaling is provided from the radio unit 200 implies that radio power scaling has been performed. Hence, in some embodiments, the radio unit 200 is configured to perform (optional) step S102.

S102: The radio unit 200 applies the radio power scaling by the radio unit 200 to the signals scheduled on the resource elements in the timeslots per carrier.

There might be different reasons for the radio unit 200 to perform the radio power scaling. In some examples, the radio unit 200 is configured for radio power overbooking, and wherein radio power scaling is performed when the radio power overbooking is active in the radio unit 200. However, there could be other effects in the radio unit 200 than radio power overbooking that can force the radio unit to apply radio power scaling, for example over-heating. Hence, in some examples, the radio power scaling is performed in response to a temperature indication from the radio unit, to prevent overheating of the radio unit 200.

There might be different types of feedback information of the radio power scaling that is fed back to the baseband unit 300a from the radio unit 200.

In some non-limiting examples, the feedback information specifies any, or any combination, of: one or more time periods (for example, which symbol(s) or slot(s) were subjected to the radio power scaling) for application of the radio power scaling to the signals, magnitude (as a function of time) of the radio power scaling, and average of the radio power scaling, information of which carriers the radio power scaling was applied to. In this respect, the average might be computed using a moving average filter or an auto-regressive filter. For example, the feedback information might comprise information about the amount of radio power scaling applied (e.g., with up to x dB power backoff) and/or information about for how many carriers, or for which carriers, radio power scaling has been applied. The baseband unit 300a can then take this feedback information into consideration.

The baseband unit 300a can then use the feedback information to modify its measurements reports, by compensating measurements made by the user equipment 150 as in step S106. In this respect, the measurements might be compensated for different purposes and at different parts of the baseband unit. For example, with the example in FIG. 2, L1 functionality could handle filtering of L1 SS-RSRP, and feed processed information to the RRM unit more seldomly. Different examples of how such compensation might be performed will be disclosed below. As will also be disclosed below, generally, the type of compensation that is made depends on what type of measurement report that is being considered.

As an introductory example, the baseband unit 300a might apply more robust processing techniques (e.g., being more robust to up to x dB dynamic power changes over max y carriers). Such processing adaptation can be implemented in the baseband unit 300a alone, or by adjusting the reporting mechanisms of the user equipment, or a combination thereof. Configuration of user equipment measurement reports can be tuned, for example, using increased averaging constants, more robust thresholds, or modified event triggering settings such as additional hysteresis. Hence, in some examples the compensating involves applying any, or any combination, of: compensated average constants, compensated thresholds, compensated event triggers to the measurements.

The baseband unit 300a can compensate the measurements to reflect the actual, non-power scaled, long-term signal quality, thereby in essence inverting any effects of radio power scaling as applied by the radio unit 200. Hence, in some examples, the measurements are signal quality measurements, and the compensating involves updating the signal quality measurements to reflect a non-power scaled signal.

In some examples, the baseband unit 300a applies (additional) power boosting by up to x dB to protect cell-defining reference signals, or other types of prioritized signals. Hence, in some embodiments, at least part of the signals are downlink reference signals, or other types of prioritized signals, and the baseband unit 300a is configured to perform (optional) step S110:
S110: The baseband unit 300a boosts power of the downlink reference signals, or of the other types of prioritized signals, upon the baseband unit 300a having received the feedback information of the radio power scaling.

In some examples, the baseband unit 300a adjusts scheduler rules to hamper any effects of radio power scaling. This could, for example, be achieved by deactivating carrier(s) when transmitting prioritized signals to ensure that power scaling is unlikely to be employed by the radio unit 200.

There may be different ways for the radio unit 200 to provide the feedback information of radio power scaling to the baseband unit 300a.

In some aspects, the baseband unit 300a is statically (e.g., only once) or semi-statically (e.g. the feedback information is provided upon reconfiguration of the radio unit 200). Alternatively, the feedback information is provided upon request from the baseband unit 300a. Other alternatives are also possible, as will be disclosed below.

In some aspects, the radio unit 200 is configured to dynamically feed back information of the radio power scaling status. In some examples, information of the radio power scaling status is only fed back from the radio unit 200 to the baseband unit 300a when radio power scaling is applied.

For example, the feedback information might be provided per each timeslot the radio unit 200 is applying the radio power scaling. This implies that the radio unit 200 might inform the baseband unit 300a whenever the radio unit 200 has applied radio power scaling (and, optionally, how much the power has been scaled).

For example, L3 filtered SS-RSRP measurement reports might be compensated by a scale factor that is given by the sum of the power scaling values corresponding to the SSB transmission periodicity over the L3 filter time constant. In particular, in some examples, at least part of the signals are periodically scheduled downlink reference signals, and when the measurement report is a L3 filtered SS-RSRP measurement report, the compensating involves scaling the measurement with a power scaling factor corresponding to a sum of the radio power scaling as applied during a measurement period. In this respect, the transmission periodicity of the downlink reference signals and L3 filtering time constants are assumed to be known by the baseband unit 300a.

For example, for L1 filtered SS-RSRP measurement reports, the baseband unit 300a performs the time filtering explicitly. Hence, measurements in L1 filtered SS-RSRP measurement reports need only be compensated by the corresponding power scaling factor. In particular, in some examples, when the measurement report is a L1 filtered SS-RSRP measurement report, the compensating involves scaling the measurement with a power scaling factor corresponding to the radio power scaling as applied to the signals.

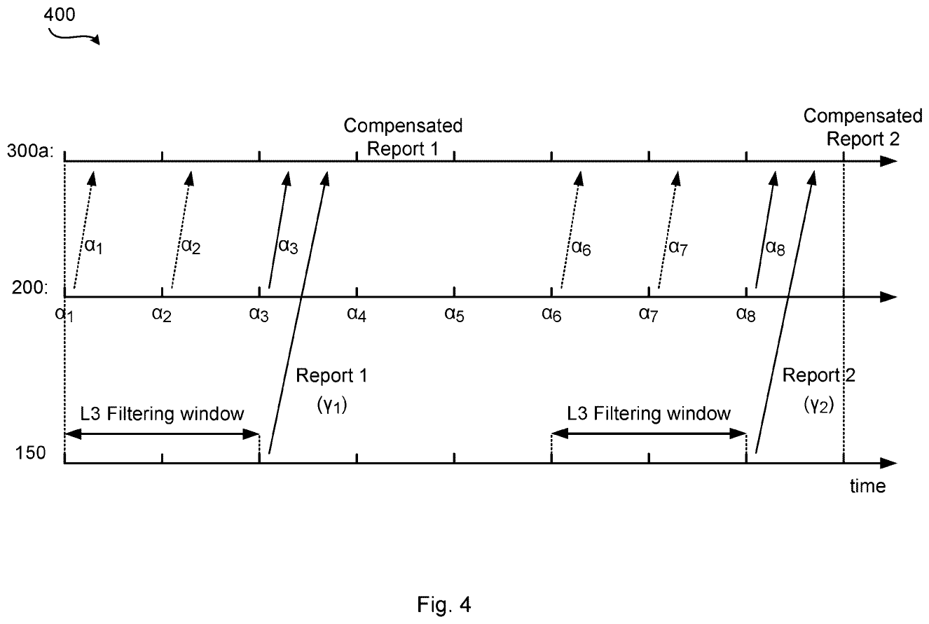

In some aspects, the radio unit 200 is configured to semi-dynamically feed back information of the radio power scaling status. This implies that the provision of feedback information from the radio unit 200 to the baseband unit 300a can be selectively triggered, for example to save interface bandwidth resources. For example, for SS-RSRP, the feedback information can be aligned with the periodicity of SSB transmissions. That is, in scenarios where at least part of the signals are downlink reference signals scheduled in timeslots, the feedback information might be provided with a timing relative the timeslots, such as once per every k:th timeslot, where k≥1 is an integer. Hence, whenever an SSB is being transmitted, the radio unit 200 feeds back information of the associated power scaling status to the baseband unit 300a. In another example, for SS-RSRP, the feedback can be aligned with the periodicity of SS-RSRP reports. In some related examples, the measurement report might be part of periodically received measurement reports from the user equipment 150, where the feedback information is provided with same periodicity as the measurement reports are received from the user equipment 150. The radio unit 200 could then report the accumulated radio power scaling corresponding to the SSB transmission and the L3 filtering time constants. The baseband unit 300a would consequently receive an SS-RSRP measurement report from the user equipment and an accumulated radio power scaling report from the radio unit 200. These two reports can then be combined by the baseband unit 300a into an effective SS-RSRP measurement. Reference is here made to FIG. 4 which at reference numeral 400 schematically illustrates actions made by a baseband unit 300a, a radio unit 200, and a user equipment 150 during periodic transmission of a downlink reference signal, in terms of an SSB. There are eight transmissions of the SSB and the scale factor applied by the radio power scaling for transmission instant k is denoted αₖ, for k=1, 2, . . . , 8. The user equipment applies L3 filtering over three consecutively received SSBs and reports an SS-RSRP value γᵢ, where i=1, 2. The baseband unit 300a then compensates the received SS-RSRP value by the corresponding power scaling factor. The power scaling factors for report 1 and 2 are α₁+α₂+α₃ and α₆+α₇+α_{g}, respectively. The radio unit 200 feeds back the power scaling factors to the baseband unit 300a. Dotted arrows illustrate that the radio unit 200 may explicitly report all individual power scaling factors corresponding to an SSB transmission, or the radio unit 200 could report the sum of all power scaling values associated with a specific report. In this way, time stamps of the feedback information from the radio unit 200 could be paired with the time instances of the reference signal transmissions, and then to the measurement reports.

In some aspects, RRM might require measurement reports from the user equipment not only from measurements made in the serving cell but also in neighboring cells.

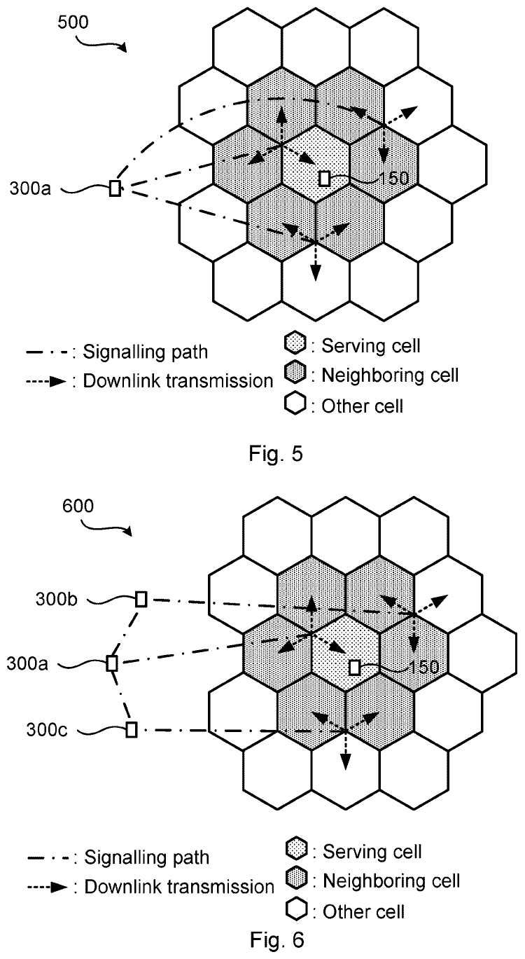

This implies that all radio units transmitting cell-defining reference signals in the cells being measured on and reported by a user equipment need to provide feedback information to all relevant baseband entities regarding any radio power scaling applied at the radio units. In essence, each radio unit 200 might feed back information about the status of radio power scaling to their associated baseband units. The baseband units then need to relay this information to relevant other baseband units via an appropriate interface. Different examples relating to this will be disclosed next with reference to FIG. 5 and FIG. 6. FIG. 5 and FIG. 6 illustrate respective communication networks 500, 600 comprising a number of cells, where a user equipment is served in one of the cells; this cell is denoted serving cell, whereas the cells surrounding the serving cell are denoted neighboring cells. In general terms, the baseband unit of the serving cell needs to know if any of the radio units have performed radio power scaling when transmitting downlink reference signals, since this could impact actions taken by the baseband unit 300a as a function of the received measurement reports from the user equipment. Examples of such actions will be disclosed below. Each cell in FIG. 5 and FIG. 6 corresponds to one radio unit. That is, one radio unit is configured to transmit downlink reference signals in a respective cell.

In FIG. 5 is illustrated an example of intra-node reports for 3-sector radio sites in a hexagonal deployment, where a user equipment is measuring the signal quality of downlink reference signals transmitted from a radio unit in the serving cell as well as from radio units in the neighboring cells. The measurements are by the user equipment reported back to the baseband unit 300a associated with the serving cell. That is, all radio units 200 transmitting the reference signals are configured to provide feedback information regarding any applied radio power scaling to the baseband unit 300a associated with the serving cell.

In FIG. 6 is illustrated an example of inter-node reports for 3-sector radio sites in a hexagonal deployment, where a user equipment is measuring the signal quality of downlink reference signals transmitted from a radio unit in the serving cell as well as from radio units in the neighboring cells, in the same way as in FIG. 5. Also as in FIG. 5, measurements are by the user equipment reported back to the baseband unit 300a associated with the serving cell. However, different from FIG. 5, the radio units are configured to only provide feedback information regarding any applied radio power scaling to its own baseband unit. The baseband units then provide the feedback information to other relevant baseband units. Hence, in some examples, the measurement report comprises further measurements made by the user equipment 150 on further signals as transmitted by a further radio unit, where information of any radio power scaling as applied by the further radio unit to the further signals is obtained by the baseband unit 300a from a further baseband unit 300b, 300c associated with the further radio unit. In some examples, the further measurements are, by the baseband unit 300a, compensated by a further factor given by any radio power scaling.

In some aspects, there could be different uses of the measurements as compensated. In some examples, the measurements as compensated are used for traffic and mobility handling, etc. In particular, in some embodiments, the baseband unit 300a is configured to perform step S108.

S108: The baseband unit 300a performs an action for the user equipment 150 as a function of the measurement as compensated.

In some non-limiting examples, the action pertains to any of: selection of transmission parameters for the user equipment 150, selection of serving beam for the user equipment 150, selection of transmission and reception point for the user equipment 150, adjustment of scheduling rules for the user equipment 150, carrier selection for the user equipment 150.

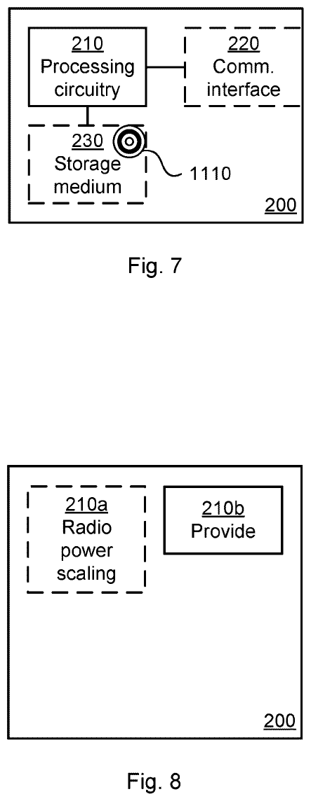

FIG. 7 schematically illustrates, in terms of a number of functional units, the components of a radio unit 200 according to an embodiment. Processing circuitry 210 is provided using any combination of one or more of a suitable central processing unit (CPU), multiprocessor, microcontroller, digital signal processor (DSP), etc., capable of executing software instructions stored in a computer program product 1110a (as in FIG. 11), e.g. in the form of a storage medium 230. The processing circuitry 210 may further be provided as at least one application specific integrated circuit (ASIC), or field programmable gate array (FPGA).

Particularly, the processing circuitry 210 is configured to cause the radio unit 200 to perform a set of operations, or steps, as disclosed above. For example, the storage medium 230 may store the set of operations, and the processing circuitry 210 may be configured to retrieve the set of operations from the storage medium 230 to cause the radio unit 200 to perform the set of operations. The set of operations may be provided as a set of executable instructions. Thus the processing circuitry 210 is thereby arranged to execute methods as herein disclosed.

The storage medium 230 may also comprise persistent storage, which, for example, can be any single one or combination of magnetic memory, optical memory, solid state memory or even remotely mounted memory.

The radio unit 200 may further comprise a communications interface 220 for communications with other entities, functions, nodes, and devices, as illustrated in FIGS. 1, 2, 4, 5, and 6. As such the communications interface 220 may comprise one or more transmitters and receivers, comprising analogue and digital components.

The processing circuitry 210 controls the general operation of the radio unit 200 e.g. by sending data and control signals to the communications interface 220 and the storage medium 230, by receiving data and reports from the communications interface 220, and by retrieving data and instructions from the storage medium 230. Other components, as well as the related functionality, of the radio unit 200 are omitted in order not to obscure the concepts presented herein.

FIG. 8 schematically illustrates, in terms of a number of functional modules, the components of a radio unit 200 according to an embodiment. The radio unit 200 of FIG. 8 comprises a provide module 210b configured to perform step S104a. The radio unit 200 of FIG. 8 may further comprise a radio power scaling mode 210a configured to perform step S102. In general terms, each functional module 210a:210b may be implemented in hardware or in software. Preferably, one or more or all functional modules 210a:210b may be implemented by the processing circuitry 210, possibly in cooperation with the communications interface 220 and/or the storage medium 230. The processing circuitry 210 may thus be arranged to from the storage medium 230 fetch instructions as provided by a functional module 210a: 210b and to execute these instructions, thereby performing any steps of the radio unit 200 as disclosed herein.

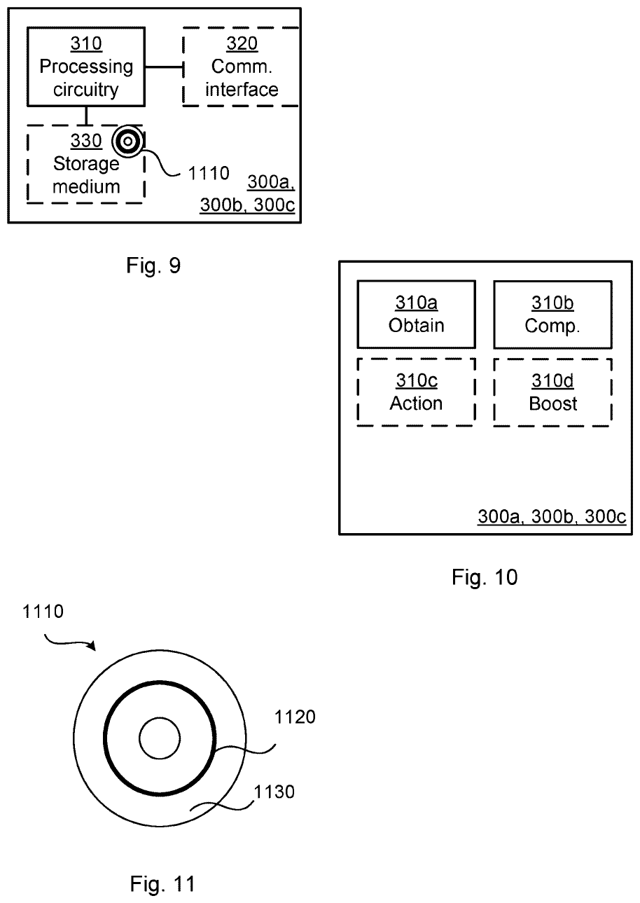

FIG. 9 schematically illustrates, in terms of a number of functional units, the components of a baseband unit 300a according to an embodiment. Processing circuitry 310 is provided using any combination of one or more of a suitable central processing unit (CPU), multiprocessor, microcontroller, digital signal processor (DSP), etc., capable of executing software instructions stored in a computer program product 1110b (as in FIG. 11), e.g. in the form of a storage medium 330. The processing circuitry 310 may further be provided as at least one application specific integrated circuit (ASIC), or field programmable gate array (FPGA).

Particularly, the processing circuitry 310 is configured to cause the baseband unit 300a to perform a set of operations, or steps, as disclosed above. For example, the storage medium 330 may store the set of operations, and the processing circuitry 310 may be configured to retrieve the set of operations from the storage medium 330 to cause the baseband unit 300a to perform the set of operations. The set of operations may be provided as a set of executable instructions. Thus the processing circuitry 310 is thereby arranged to execute methods as herein disclosed.

The storage medium 330 may also comprise persistent storage, which, for example, can be any single one or combination of magnetic memory, optical memory, solid state memory or even remotely mounted memory.

The baseband unit 300a may further comprise a communications interface 320 for communications with other entities, functions, nodes, and devices, as illustrated in FIGS. 1, 2, 4, 5, and 6. As such the communications interface 320 may comprise one or more transmitters and receivers, comprising analogue and digital components.

The processing circuitry 310 controls the general operation of the baseband unit 300a e.g. by sending data and control signals to the communications interface 320 and the storage medium 330, by receiving data and reports from the communications interface 320, and by retrieving data and instructions from the storage medium 330. Other components, as well as the related functionality, of the baseband unit 300a are omitted in order not to obscure the concepts presented herein.

FIG. 10 schematically illustrates, in terms of a number of functional modules, the components of a baseband unit 300a according to an embodiment. The baseband unit 300a of FIG. 10 comprises a number of functional modules; an obtain module 310a configured to perform step S104b, and a compensate module 310b configured to perform step S106. The baseband unit 300a of FIG. 10 may further comprise a number of optional functional modules, such as any of an action module configured to perform step S108, and a boost module 310d configured to perform step S110. In general terms, each functional module 310a:310d may be implemented in hardware or in software. Preferably, one or more or all functional modules 310a:310d may be implemented by the processing circuitry 310, possibly in cooperation with the communications interface 320 and/or the storage medium 330. The processing circuitry 310 may thus be arranged to from the storage medium 330 fetch instructions as provided by a functional module 310a:310d and to execute these instructions, thereby performing any steps of the baseband unit 300a as disclosed herein.

FIG. 11 shows one example of a computer program product 1110a, 1110b comprising computer readable means 1130. On this computer readable means 1130, a computer program 1120a can be stored, which computer program 1120a can cause the processing circuitry 210 and thereto operatively coupled entities and devices, such as the communications interface 220 and the storage medium 230, to execute methods according to embodiments described herein. The computer program 1120a and/or computer program product 1110a may thus provide means for performing any steps of the radio unit 200 as herein disclosed. On this computer readable means 1130, a computer program 1120b can be stored, which computer program 1120b can cause the processing circuitry 310 and thereto operatively coupled entities and devices, such as the communications interface 320 and the storage medium 330, to execute methods according to embodiments described herein. The computer program 1120b and/or computer program product 1110b may thus provide means for performing any steps of the baseband unit 300a as herein disclosed.

In the example of FIG. 11, the computer program product 1110a, 1110b is illustrated as an optical disc, such as a CD (compact disc) or a DVD (digital versatile disc) or a Blu-Ray disc. The computer program product 1110a, 1110b could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1120a, 1120b is here schematically shown as a track on the depicted optical disk, the computer program 1120a, 1120b can be stored in any way which is suitable for the computer program product 1110a, 1110b.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for measurement compensations due to radio power scaling, wherein the method comprises:
providing, from a radio unit to a baseband unit, feedback information of radio power scaling as applied by the radio unit to signals scheduled on resource elements in timeslots per carrier; and
compensating, by the baseband unit, measurements made by a user equipment on the signals as transmitted by the radio unit, wherein the measurements are received by the baseband unit from the user equipment in a measurement report, and wherein the measurements are compensated by a factor given by the radio power scaling.

2. The method according to claim 1, wherein the method further comprises:
applying the radio power scaling by the radio unit to the signals scheduled on the resource elements in the timeslots per carrier.

3. The method according to claim 1, wherein the measurements are signal quality measurements, and wherein the compensating involves:
updating the signal quality measurements to reflect a non-power scaled signal; and
applying any, or any combination, of: compensated average constants, compensated thresholds, and compensated event triggers to the measurements.

4. (canceled)

5. The method according to claim 1, wherein at least part of the signals are periodically scheduled downlink reference signals, and wherein when the measurement report is a protocol layer 3, L3, filtered synchronization signal reference signal received power, SS-RSRP, measurement report, the compensating involves scaling the measurement with a power scaling factor corresponding to a sum of the radio power scaling as applied during a measurement period.

6. The method according to claim 1, wherein when the measurement report is a protocol layer 1, L1, filtered synchronization signal reference signal received power, SS-RSRP, measurement report, the compensating involves scaling the measurement with a power scaling factor corresponding to the radio power scaling as applied to the signals.

7. The method according to any preceding claim 1, wherein the feedback information specifies any, or any combination, of: a time period for application of the radio power scaling to the signals, a magnitude of the radio power scaling, an average of the radio power scaling, and information of which carriers the radio power scaling was applied to.

8. The method according to claim 1, wherein the feedback information is provided upon request from the baseband unit.

9. The method according to claim 1, wherein the feedback information is provided upon reconfiguration of the radio unit.

10. The method according to claim 1, wherein at least part of the signals are downlink reference signals scheduled in timeslots, and wherein the feedback information is provided with a timing relative the timeslots, such as once per every k:th timeslot, where k≥1 is an integer.

11. The method according to claim 1, wherein the measurement report is part of periodically received measurement reports from the user equipment, and wherein the feedback information is provided with same periodicity as the measurement reports are received from the user equipment.

12. The method according to claim 1, wherein the feedback information is provided per each timeslot the radio unit is applying the radio power scaling.

13. The method according to claim 1, wherein the method further comprises:
performing an action for the user equipment as a function of the measurement as compensated.

14. The method according to claim 13, wherein the action pertains to any of: selection of transmission parameters for the user equipment, selection of serving beam for the user equipment, selection of transmission and reception point for the user equipment, adjustment of scheduling rules for the user equipment, carrier selection for the user equipment.

15. The method according to claim 1, wherein at least part of the signals are downlink reference signals, and wherein the method further comprises:
boosting power, by the baseband unit, of the downlink reference signals upon the baseband unit having received the feedback information of the radio power scaling.

16. The method according to claim 1, wherein the measurement report comprises further measurements made by the user equipment on further signals as transmitted by a further radio unit, wherein information of any radio power scaling as applied by the further radio unit to the further signals is obtained by the baseband unit from a further baseband unit associated with the further radio unit.

17. The method according to claim 16, wherein the further measurements are, by the baseband unit, compensated by a further factor given by said any radio power scaling.

18. The method according to claim 1, wherein the radio unit is configured for radio power overbooking, and wherein radio power scaling is performed when the radio power overbooking is active in the radio unit.

19. The method according to claim 1, wherein the radio power scaling is performed in response to a temperature indication of the radio unit.

20-21. (canceled)

22. A radio unit for measurement compensations due to radio power scaling, the radio unit comprising processing circuitry, the processing circuitry being configured to cause the radio unit to:
provide, to a baseband unit, feedback information of radio power scaling as applied by the radio unit to signals scheduled on resource elements in timeslots per carrier.

23. (canceled)

24. A baseband unit for measurement compensations due to radio power scaling, the baseband unit comprising processing circuitry, the processing circuitry being configured to cause the baseband unit to:
obtain, from a radio unit, feedback information of radio power scaling as applied by the radio unit to signals scheduled on resource elements in timeslots per carrier; and
compensate measurements made by a user equipment on the signals as transmitted by the radio unit, wherein the measurements are received by the baseband unit from the user equipment in a measurement report, and wherein the measurements are compensated by a factor given by the radio power scaling.

25-28. (canceled)
